(19) United States
(12) Patent Application Publication
(10) Pub. No.: US 2012/0133527 A1
(43) Pub. Date: May 31, 2012

(54) Vehicle Guidance System

(76) Inventor: Bo-Yang Lin, Richardson, TX (US)

(21) Appl. No.: 12/954,894

(22) Filed: Nov. 28, 2010

(51) Int. Cl. B60Q 1/48

(52) U.S. Cl. 340/932.2

(57) ABSTRACT

The present invention relates to a method of using the disappearance of a laser projection for the parking of a vehicle. Project a laser beam onto an object inside a garage directly or through a reflector so that the projection is visible to a vehicle driver. The laser beam is set up in such a manner that its path is just blocked by a correctly parked vehicle. When one drives a vehicle to this location, the laser beam is blocked and the earlier visible projection disappears, telling the driver to stop. This set up allows the driver to park the vehicle at the correct location repeatedly.

### CROSS-REFERENCE TO RELATED APPLICATIONS

(Not Applicable)

### STATEMENT REGARDING FEDERALLY SPONSORED RESEARCH/DEVELOPMENT

(Not Applicable)

### BACKGROUND OF THE INVENTION

As is desired, one needs to park a vehicle inside a garage at a correct location in a repeatable fashion. Otherwise, the vehicle may hit the front wall of the garage, or the closing garage door may hit the vehicle.

Many parking aids have been introduced in the past in order to achieve repeatable parking of a vehicle at a specific location inside a garage. Some examples of the prior arts are: a mat with a raised linear bump; a suspended tennis ball; a flexible post standing in front of where a car should be parked. Many of the prior arts have been patented, such as the usage of an alignment system by Dover (U.S. Pat. No. 5,992,343) and by Randhawa (U.S. Pat. No. 7,124,705); the usage of a distance detector by Yaron et al (U.S. Pat. No. 5,945,907); the direct usage of a laser to aim at a fixed location on a correctly parked vehicle by Kositkun et al (U.S. Pat. No. 6,191,706) and by Yanda (U.S. Pat. No. 6,946,973); the usage of a light emitting source placed on an overhead structure coupled with a photoelectric transducer facing a generally downward direction to detect upwardly reflected light by Barkley et al. (U.S. Pat. No. 4,808,997).

Although set ups for assisting vehicle parking are many, each of these set ups has its own problems. For example, a mat with a raised linear bump for assisting parking tends to move around which makes it difficult to park at the same location repeatedly. The usage of a tennis ball is effective but rather difficult to install since it has to be hang from the ceiling. The set up of using a laser to shine at a specific location on a vehicle to park repeatedly (Kositkun, U.S. Pat. No. 6,191,706 and Yanda, U.S. Pat. No. 6,946,973) has several problems. For instance, the scattered laser beam on a vehicle may accidentally hit a driver's eye and cause discomfort. Also, since the laser is rather bright and the specific location of the beam is usually right above the driver dashboard which is very close to the driver, it is rather uncomfortable to look at the laser spot to help with parking. Thirdly, as shown in U.S. Pat. Nos. 6,191,706 and 6,946,973, the laser is mounted on the garage ceiling, which is not the most convenient place to carry out an installation.

The set up recommended by Barkley et al. (U.S. Pat. No. 4,808,997) is very limiting. It requires the light source to emit in a generally downward direction from an overhead mounting location coupled with a photoelectric transducer in a generally downward direction for receiving upwardly reflected light. This set up requires the placement of both the source and detector on the ceiling of a garage which is again inconvenient.

Consequently, there is a need for an improved parking aid which is the impetus for this invention.

### BRIEF SUMMARY OF THE INVENTION

The present invention relates to a method of using the disappearance of a laser projection for the parking of a vehicle. Project a laser beam onto an object inside a garage directly or through a reflector so that the projection is visible to a vehicle driver. The laser beam is set up in such a manner that its path is just blocked by a correctly parked vehicle. When one drives a vehicle to this location, the laser beam is blocked and the earlier visible projection disappears, telling the driver to stop. This set up allows the driver to park the vehicle at the correct location repeatedly.

### BRIEF DESCRIPTION OF THE DRAWINGS

FIG. 1: Illustration of a laser (1) placed on a garage floor. The solid vertical line represents the garage front wall and the solid horizontal line represents the garage floor. The laser beam (11) from the laser projects onto the garage front wall becoming visible (3) to a driver. The laser is mounted on a base and the angle between the base and the laser is adjustable so as to make the set up simple.

FIG. 2: The laser is placed in such a way that when one drives a vehicle into the garage and reaches its correct parking location, the laser beam (11) is just blocked and the laser projection on the front wall (point 3) disappears, telling the driver to stop.

FIG. 3: Illustration of a vehicle parked at the correct location inside a garage.

FIG. 4: A laser (1) is mounted on the front wall of a garage. Adjust the angle between the laser base and the laser so that the laser beam (11) is directed in such a way that its path is just blocked by the vehicle.

FIG. 5: Place a reflector at the location where the laser beam projects onto the garage floor, so that the reflected laser beam (12) projects onto the garage wall at location 3, visible to the driver. The dotted figure is the removed vehicle in the correct parking location.

FIG. 6: When one drives a vehicle into the garage and reaches its correct parking location, the direct laser beam (11) is blocked and the reflected beam on the front wall (location 3) disappears.

FIG. 7: The parked vehicle blocks the reflected beam (12) instead of the direct beam (11).

FIG. 8: Place a lens (4) in front of the laser to expand the laser beam so that the projection (3) on the wall is spread two dimensionally as shown by 3a which is a head on view of the laser projection.

FIG. 9: With an expanded laser beam, the vehicle does not have to block the entire beam when parked in the correct location. Instead, only part of the beam can be blocked so that part of the laser projection on the wall is still visible as shown by 3b in FIG. 9, which is the head on view of the laser projection on the front wall. Line X in 3b of FIG. 9 is the division above which the two dimensional projection is blocked by the vehicle.

### DETAILED DESCRIPTION OF THE INVENTION

As is desired, one needs to park a vehicle inside a garage at a correct location in a repeatable fashion. Otherwise, the vehicle may hit the front wall of the garage, or the closing garage door may hit the vehicle.

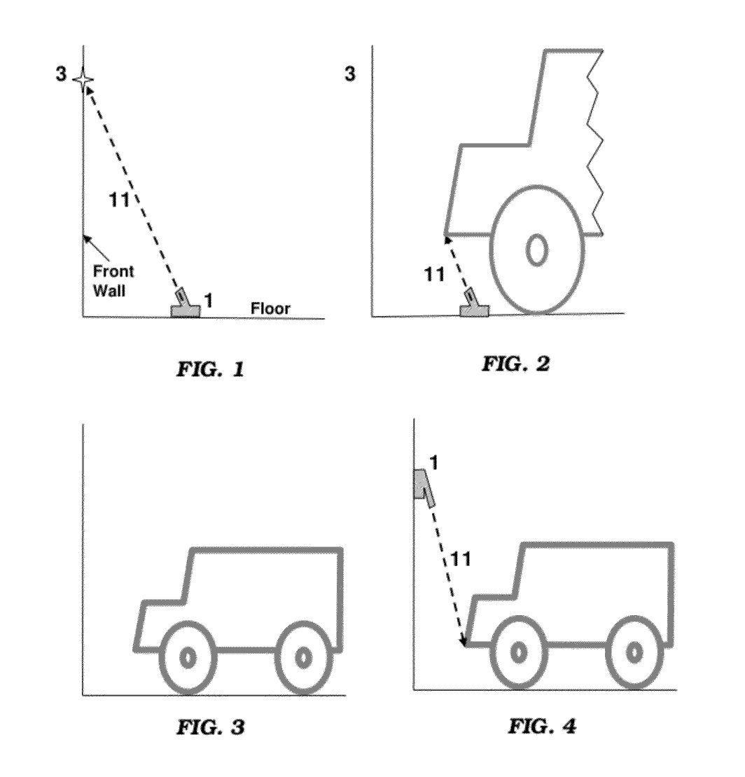

The present invention relates to a method of assisting the correct parking of a vehicle. In one embodiment (FIG. 1), one sets up a laser on a garage floor and the laser beam (11) projects onto the front wall of the garage at location 3 where the beam becomes visible to the driver of a parking vehicle. The laser is mounted on a base and the angle between the base and the laser is adjustable so as to make the set up simple.

The laser needs to be placed in such a way that when one drives a vehicle into the garage and reaches its correct parking location, the laser beam (11) is just blocked (FIG. 2) causing the laser projection on the front wall to disappear and telling the driver to stop. This set up allows the driver to park the vehicle at the correct location repeatedly.

It is obvious that the laser does not have to be placed on the garage floor nor the laser projection has to be on the front wall of a garage so long as the system comprising of the following two points: First, the laser projects onto an object such that the laser beam becomes visible to the vehicle driver; Second, when the vehicle reaches the correct parking location, the laser beam is just blocked so that the visible projection disappears.

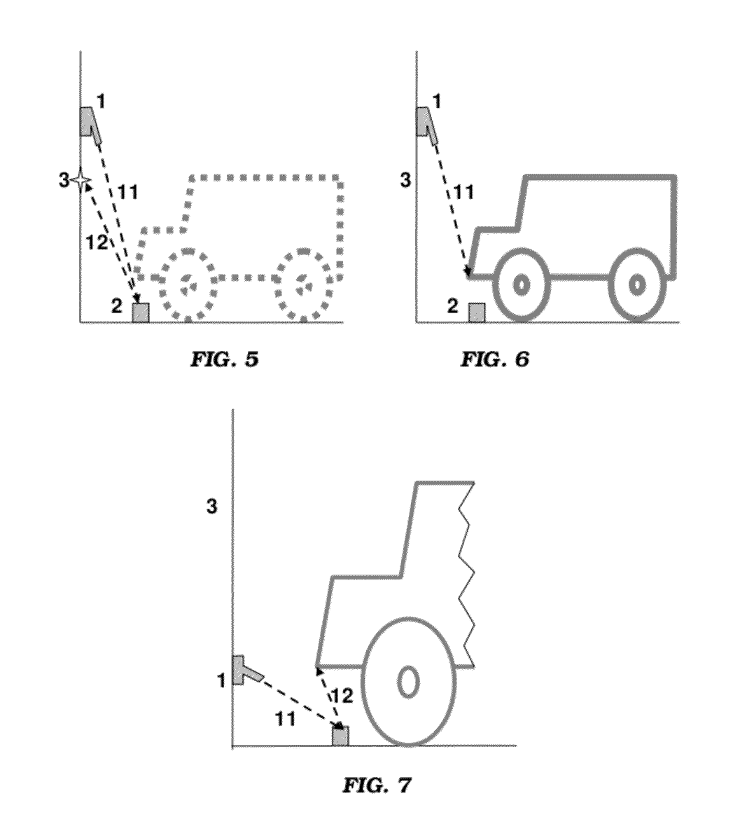

In another embodiment, the visible laser projection is not formed from the direct laser beam, but is from a reflection of the direct beam through the usage of a reflector. The usage of a reflector enables the placement of the laser at convenient locations not possible without the reflector. To set this up, one parks a vehicle at a desired location inside a garage as illustrated in FIG. 3. Mount a laser (1) on the front wall, for example, of the garage as shown in FIG. 4. Adjust the angle between the laser base and the laser so that the laser beam (11) is directed in such a way that its path is just blocked by the vehicle. Remove the vehicle so the laser beam projects onto the garage floor. As shown in FIG. 5, place a reflector (2) at the location where the laser beam projects onto the garage floor, so that the reflected laser beam (12) projects onto the garage front wall at location 3. The dotted drawing in FIG. 5 is the removed vehicle in the correct parking location.

As shown in FIG. 6, when one drives a vehicle into the garage and reaches its correct parking location, the direct laser beam (11) is blocked and the reflected beam at location 3 on the front wall disappears, telling the driver to stop. This set up allows the driver to park the vehicle at the correct location repeatedly.

It is evident that instead of the direct beam being blocked by the correctly parked vehicle, the blocked beam can be the reflected beam (12) as shown in FIG. 7 where the laser is mounted at a different, or a lower, location from that in FIGS. 4-6.

Another embodiment involves the modification of a laser beam which is usually very narrow. One can place a lens (4) in front of the laser so that the laser beam expands as shown in FIG. 8, where the expansion of the laser beam continues after reflecting off the reflector (2). The projection on the garage wall is spread two dimensionally as shown by 3a which is the head on view of the laser projection 3 on the garage front wall. The enlargement of the laser projection can also be achieved by taking advantage of the natural divergence of a diode laser by, e.g., placing the accompanying collimating lens away from the optimum position. This and other techniques are well known to people working in optics. The expansion of the beam can also be from the reflector used to reflect the laser beam. This can be achieved, e.g., by using a concave or convex shaped reflector. The enlargement of the laser projection should be at least 2 times the laser beam spatial width as it exits the laser and makes the laser projection easier to see to the driver.

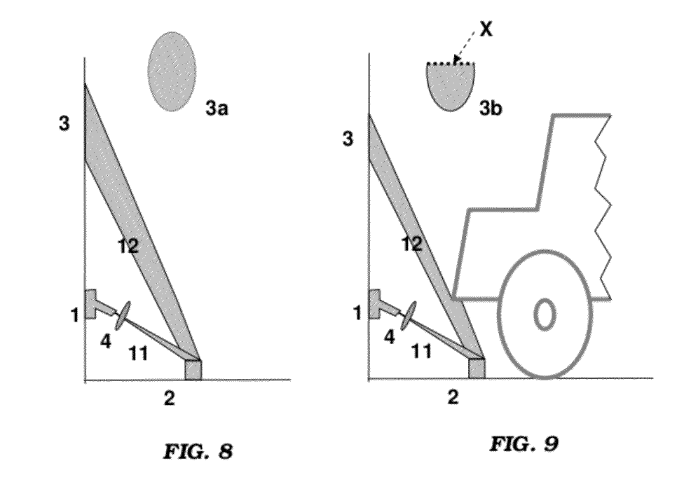

With an expanded laser beam, the vehicle does not have to block the entire beam when parked in the correct location. Instead, only part of the beam can be blocked so that part of the laser projection on the wall is still visible as shown by 3b in FIG. 9, which is the head on view of the laser projection on the front wall. Line X in 3b of FIG. 9 is the division above which the two dimensional projection is blocked by the vehicle. Since the blocking of the expanded projection on the wall is not instantaneous, one may also mark the correct parking location to be somewhere in-between the beginning blocking of the expanded projection and the complete blocking of the projection.

As is obvious, the expansion of the laser beam does not have to be two dimensional, as discussed above. The expansion can be in one dimension only, by using a cylindrical lens, e.g., so that the projection on the wall is a line instead of being spread over an area. This way, the projection is brighter hence makes it easier to see, as compared to an enlarged two dimensional projection. It is preferred that the line projection on the wall is in the direction perpendicular to line X in 3b of FIG. 9 when the projection is two dimensional. This provides the vehicle the most travel to block the entire laser projection.

Since the laser for vehicle parking needs not to be turned on most of the time, it can be turn on only when a car is moving into the garage, for example. One approach to achieve this functionality is to add an electronic motion sensor, which is widely available in the market, to the laser control circuit so that the laser is turned on only when a motion is detected in the garage. The laser and the motion sensor can be either separate pieces or be integrated onto a circuit board or be integrated on a single chip—all are well known in the electronic industry.

Another example to keep the laser off most of the time is to couple the laser to the light power supply circuit for a garage door opener. Such light power supply circuit, which controls lighting on the garage door opener, only turns on when the garage door is just opened or just closed and stays on for limited amount of time. One can couple the laser to the light power supply circuit so that the laser is turned on only when the garage opener light is on.

Illustrations above provide exemplary embodiments of the present invention. The scope of the present invention is not limited by these illustrations. The number of variations, some of which are shown in this specification, is limitless. These variations may be implemented by one skilled in the art in view of this disclosure.

1. A method of assisting vehicle parking inside a garage, comprising of: projecting a visible laser beam at an object so that the beam becomes visible to a parking driver; aligning the laser beam in such a way that the beam path is just blocked by the vehicle when it reaches a desired parking location inside a garage causing the laser projection on the object to disappear which tells the driver to stop.

2. The method as claimed in claim 1 wherein the visible laser spot on an object is formed by a reflection of a primary laser beam from a reflector.

3. The method as claimed in claim 1 wherein the visible laser projection on an object has a dimension two or more times greater than the corresponding laser beam dimension when it exits the laser.

4. The method as claimed in claim 3 wherein the blocking of the beam path and the subsequent disappearance of the laser projection on an object is partial.

5. The method as claimed in claim 1 wherein the laser is turned on only when a motion is detected in the garage.

6. The method as claimed in claim 1 wherein the laser system is coupled to a garage door opener and the laser is turned on only when light from the garage door opener is turned on.
